(19) United States
(12) Patent Application Publication
(10) Pub. No.: US 2023/0180769 A1
(43) Pub. Date: Jun. 15, 2023

(54) Cookie Baking Slide (Pan)

(71) Applicant: Freddie G. Bell, Redondo Beach, CA (US)

(72) Inventor: Freddie G. Bell, Redondo Beach, CA (US)

(21) Appl. No.: 17/547,215

(22) Filed: Dec. 9, 2021

(51) Int. Cl. A21B 3/13; A47J 43/20; A47J 37/01; A47J 36/02

(52) U.S. Cl. CPC A21B 3/132; A47J 43/20; A47J 37/01; A47J 36/025

(57) ABSTRACT

The Cookie Baking Slide is a form of bakeware for cookies. The pan is designed just for the efficient baking of cookies and the 6 or 12-3 inch in diameter help form the symmetrical “perfect” cookie. The cookies “slide” off the pan due to the non-stick surface and/or the small grooves that form an edge for the shallow cups in the pan.

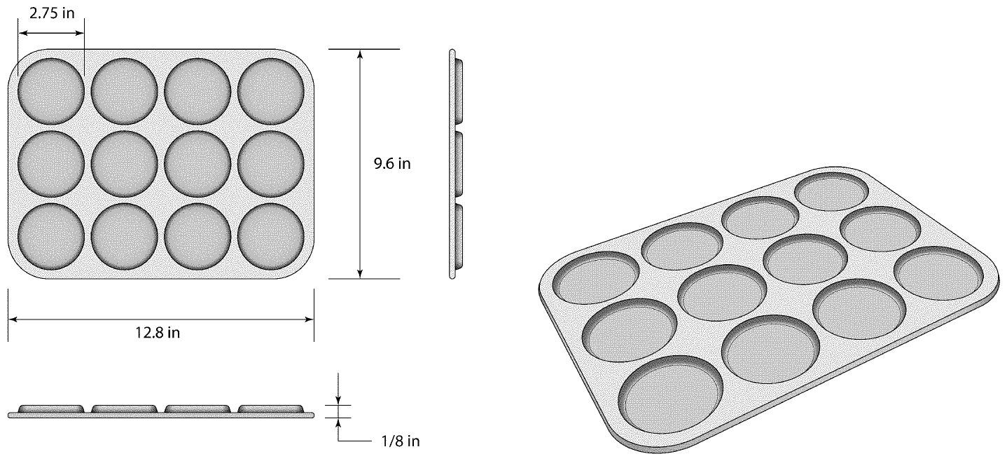

### BACKGROUND

The present invention is a device for the baking of cookie dough. The invention makes the process of baking of cookie dough faster and more efficient.

### SUMMARY

In one embodiment of the present invention, the Cookie Baking Slide provides an efficient alternative to the process baking cookies by eliminating the need for a cookie cutter. The cookies “grooves” are placed and aligned in the pan in perfect symmetrical circles. The grooves serve to restrict the cookie dough from spreading further than the desired size of the circle when backing.

### DESCRIPTION OF RELATED ART

Most if not all cookies pans are flat. A similar invention would be PATENT WO1996013170A1, a traditional muffin TIN. Which is a type of pan for baking muffins. They will have 4-12 individual round ups that form the shape of a muffin. IN addition the cookie baking sheet is a similar concept as well. U.S. Pat. No. 7,011,014B2.

### DETAILED DESCRIPTION

The Cookie Baking Pan is a 12×8 inch baking pan made out of aluminum or other baking non stick material. The pan has 6 or 12, 2¾ in or 3 inch (diameter) ⅛″ deep cups in which an individual would place their cooking batter in for baking. The pan provides 6 or 12 round shaped cookies. This eliminates the need for cookie sheets. In addition, the perfect circled cups provides spacing between each cookie eliminating the spread of the cookie batter/dough outside of the desired cookie size after the cookies begin baking.

The Cooking Baking Pan is utilized by pouring or placing cookie batter in one of the 6 or 12, 2¾ in or 4. inch (diameter) ⅛″ (depth) pockets or cups. The cup is ⅛″ of an inch deep.

Once the cookies are done, after they cool, you can remove them either turning the pan upside down or remove with a spatula.

1. Cookie Baking Slide. A bakeware pan for the purpose of baking cookies.
A rectangular flat pan with symmetrical shallow cups. Circular Cups allow cookie batter to stay within cups space and when enough batter or dough is placed within the cups the cookies forms a circular shape and stays within the grooves. Non stick shallow grooves enable cookies to “slide” off the pan, or allow for easy removal.
